(19) United States
(12) Patent Application Publication
(10) Pub. No.: US 2016/0094564 A1
(43) Pub. Date: Mar. 31, 2016

(54) TAXONOMIC MALWARE DETECTION AND MITIGATION

(71) Applicant: McAfee, Inc, Santa Clara, CA (US)

(72) Inventors: Rahul Mohandas, Kerala (IN); Lixin Lu, San Jose, CA (US); Sakthikumar Subramanian, San Jose, CA (US); Saravanan Mohankumar, Tirupur (IN); Anand Tripathi, Amethi (IN); Bharath Kumar, Sahupuram (IN); Ashish Mishra, Lal Bangla (IN); Simon Hunt, Santa Clara, CA (US); Jennifer Mankin, San Jose, CA (US); Jeffrey Zimmerman, San Jose, CA (US)

(21) Appl. No.: 14/497,757

(22) Filed: Sep. 26, 2014

(51) Int. Cl. H04L 29/06

(52) U.S. Cl. CPC H04L 63/145

(57) ABSTRACT

In an example, a classification engine compares two binary objects to determine whether they can be classified as belonging to a common family. As an example application, the classification engine may be used to detect malware objects derived from a common ancestor. To classify the object, the binary is disassembled and the resulting assembly code is normalized. Known “clean” functions, such as compiler-generated library code, are filtered out. Normalized blocks of assembly code may then be characterized, such as by forming N-grams, and checksumming each N-gram. These may be compared to known malware routines.

### FIELD OF THE DISCLOSURE

This application relates to the field of computer security, and more particularly to a system and method for taxonomic malware detection and mitigation.

### BACKGROUND

Antivirus and anti-malware research has evolved into an ongoing arms race between malware authors and security researchers. In earlier days of anti-malware research, it was sufficient for security researchers to identify and fingerprint executable objects known to be malware. An anti-malware agent on a user's computer could then search the computer for executable objects that match known malware fingerprints.

However, as malware authors have increased their efforts to avoid detection and mitigation, it has become more difficult to rely on simple fingerprinting solutions. In one example, a fingerprint of an executable object is calculated according to a checksum of the object. Checksums are an extremely efficient way to compare two binary objects and determine, with a high degree of confidence, whether they are identical. If two binary objects have the same checksum, then the two objects can be deemed identical with extremely high confidence. Thus, if an executable object is found to have the same checksum as a known malware object, then it may safely be quarantined with negligible probability of quarantining a useful object.

### BRIEF DESCRIPTION OF THE DRAWINGS

The present disclosure is best understood from the following detailed description when read with the accompanying figures. It is emphasized that, in accordance with the standard practice in the industry, various features are not drawn to scale and are used for illustration purposes only. In fact, the dimensions of the various features may be arbitrarily increased or reduced for clarity of discussion.

FIG. 1 is a block diagram of a security-enabled network according to one or more examples of the present Specification.

FIG. 2 is a block diagram of a computing device according to one or more examples of the present Specification.

FIG. 3 is a block diagram of a server according to one or more examples of the present Specification.

FIG. 4 is a flow chart of a method performed by a classification engine according to one or more examples of the present Specification.

FIG. 5 is a functional block diagram of a classification engine according to one or more examples of the present Specification.

FIG. 6 is a flow chart of a method performed by a classification engine according to one or more examples of the present Specification.

### DETAILED DESCRIPTION OF THE EMBODIMENTS

### Overview

In an example, a classification engine compares two binary objects to determine whether they can be classified as belonging to a common family. As an example application, the classification engine may be used to detect malware objects derived from a common ancestor. To classify the object, the binary is disassembled and the resulting assembly code is normalized. Known “clean” functions, such as compiler-generated library code, are filtered out. Normalized blocks of assembly code may then be characterized, such as by forming N-grams, and checksumming each N-gram. These may be compared to known malware routines.

### Example Embodiments of the Disclosure

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed.

Different embodiments many have different advantages, and no particular advantage is necessarily required of any embodiment.

Checksum-based fingerprinting techniques and other well-used malware detection methods are subject to concealment techniques by malware authors. For example, although checksumming is an extremely fast and accurate way to compare two binary objects, it is also trivial to defeat by, for example, making minor changes to a malware object and recompiling. Because even minor changes completely alter the checksum, the recompiled malware object must be independently discovered and characterized anew.

Thus, one aspect of the arms race between security researchers and malware authors is that malware authors may frequently make subtle changes to malware objects to defeat old checksums. These new malware objects are then released into the wild, where they may cause some degree of harm before security researchers are able to identify them and update their checksum. This poses particular dangers for so-called “zero day” exploits, wherein a malware object remains undetected until it reaches a date and time or other condition of its choosing, at which point all copies of the malware object in the wild simultaneously deliver a payload. In the case of a zero day exploit, a great deal of damage may be done before the object is detected and antimalware agents are updated with the new checksum.

Another useful method for detecting malware objects is to run new, suspect executable objects in a sandbox environment, and to monitor them to see whether they exhibit malware behavior. As with checksumming, this method provides a very valuable service, but malware authors have adapted. In some cases, malware authors will use environmental triggers to prevent malware objects from delivering their payload on all machines. This may include, for example, checking whether the MAC address of a network card on an infected machine has a particular sequence of digits, whether the IP address meets certain criteria, or any other pseudorandom factor. This makes it less likely that a particular sandbox environment will trip the environmental trigger and detect the malware payload. While this technique means that of N infected computers, only k·N, (k<1) machines will actually receive the payload, the barriers against detection may help the malware object to remain undetected longer, and thus realize a net increase of payload deliveries.

Malware authors may also use obfuscation techniques such as compressors, protectors, crypt doors, binders, multilayer packets, and similar to avoid detection. In some cases, commercially-available remote administration tools (RATs) are modified to contain anti-debugging and anti-virtualization capabilities, making them more effective as malicious tools.

The applicants of the present Specification have recognized that while current malware detection approaches perform valuable service, it is useful to provide novel methods whereby malware objects can be detected and remediated well before they have a chance to deliver a payload. In one example, a classification engine is provided, included hardware and software operable for analyzing an executable object and determining, with a high level of confidence, whether the executable object belongs to a “family” of malware objects in a malware taxonomy.

This method recognizes that although a checksum may be defeated, for example, by a minor change such as a recompile, many of the essential characteristics of the malware object remain the same. Specifically, like most software, malware is not generally developed from scratch. Rather, malware authors may rely on libraries of malware routines, similar to the libraries of useful and legitimate routines that other software developers share. Thus, while every individual malware object may have a separate checksum, a large number of malware objects may share certain characteristics. Thus, a “fuzzy fingerprint” may be calculated to detect not only the checksum of an executable object, but also to classify the object as belonging to a malware family by detecting the presence of certain common subroutines or functions.

Family classification is a method of identifying similar executable objects via static code analysis. While detection and classification is described herein as an example of family classification, the system and methods disclosed are, in fact, equally applicable to any case where it is useful or valuable to compare executable objects or other binary objects for substantial similarity. Thus, the system and method disclosed herein may be equally applicable, for example, to an application of detecting copyright infringement. Throughout the remainder of this Specification, family classification and a classification engine will be described with particular reference to malware detection as an example. This example is, however, intended to be non-limiting.

Family classification uses disassembly of executable object to calculate similarity between an object under analysis and zero or more families of known malware objects, thus potentially classifying the object under analysis as belonging to a malware family.

The approach of the present Specification is effective and scalable for detecting many evasive families or classes of malware objects. The classification engine may use code instruction semantics, filters for filtering out library- or compiler-produced code, so that analysis is performed only on user-defined code. This increases the malware detection rate while simultaneously reducing false positives.

The classification engine is scalable and efficient. It detects library code reuse by finding common code sequences between malicious objects. The classification engine may also track common code segments associated with a malware family in an effective manner. Thus, targeted attacks may be identified, tracked, and prevented in a proactive fashion.

In light of the inherent challenges of multiple obfuscation techniques, a hybrid approach may also be used where detection is based on either the complete user code or certain blocks of code or functions that are relevant to malware objects.

According to one embodiment of the present Specification, an executable object is subjected to sandbox dynamic analysis to identify classification candidates. Once a classification candidate is identified, it is treated as an object under analysis for a classification engine.

The executable object is disassembled, producing an “ASM” assembly listing file. In some cases, the ASM listing may be conditioned into a call trace. As used throughout this Specification, a “call trace” is a skeleton or framework useful for fuzzy matching by a classification engine, and may specifically remove call order from matching functions. Thus, with a call trace, two functions may match if they have similar calls, even if those calls are in slightly different order.

The classification may then use a clean function list (CFL) to filter out compiler-produced code and to reduce noise and measurement of similarity between candidate malware routines. To achieve this in one embodiment, files from different compilers are collected, and fuzzy hashes are created to identify and isolate clean functions. At this stage, functions from common library routines, or other compiler-produced code may be removed.

For example, a common subroutine in the C programming language is the “secure string copy” function strncpy_s( ). One example of an Intel® x86 realization of this function is as follows:

| | |
|---|---|
| :00403912 55 | push ebp |
| :00403912 8bec | mov ebp, esp |
| :00403915 53 | push ebx |
| :00403916 56 | push esi |
| :00403917 8b75 08 | mov esi, dword ptr ss:[ebp + 8] |
| :0040391a 33db | xor ebx, ebx |
| :0040391c 395d 14 | cmp dword ptr ss:[eb + 14], ebx |
| :0040391f 57 | push edi |
| :00403920 75 10 | jnz short 0043932 |
| :00403922 3bf3 | cmp esi, ebx |
| :00403924 75 10 | jnz 0040393d |
| :00403926 395d 0c | cmp dword ptr ss:[ebp + c], ebx |
| :00403929 75 12 | jnz short 0040393d |
| :0040392b 33c0 | xor eax, eax |
| :0040392d 5f | pop edi |
| :0040392e 5e | pop esi |
| :0040392f 5b | pop ebx |
| :00403930 5d | pop ebn |
| :00403931 c3 | retn |

Each line of the foregoing listing is of the form:

| | |
|---|---|
| :[ADDRESS] [OPCODE] | [MNEMONIC] [OPERANDS] |

A hash of this function is 068a67f4ac41399c4d48128bff929ffc. In one example, a classification engine thus identifies this listing as belonging to the strncpy_s( ) function, which is a standard library function. Thus, the inclusion of this routine provides little to no information about whether the object under analysis is malicious, or how to classify it. Checksums of implementations of the same function from different compilers and libraries may further be provided. Thus, when a classification engine encounters a binary object with a block of code that matches one of these checksums, or a fuzzy fingerprint of this routine, it may confidently assert that this is a compiler-generated strncpy_s( ) function that, for purposes of efficiency, may safely be filtered out.

In another example, a “blacklist” of malware functions may be provided. This may include a similar library of fuzzy hashes that match known functions that should not appear in legitimate software or that can safely be deemed “malware functions.” Whereas “clean functions” above may be safely ignored as providing little to no useful information, the inclusion of known malware functions may indicate that the object under analysis should be blacklisted or otherwise remediated, regardless of further analysis.

Another technique that may be employed by a classification engine is “ASM normalization.” This technique recognizes that a typical assembly instruction comprises an operation code (opcode), which may correlate to a useful mnemonic, such as “MOV” or “PUSH.” This may be followed by zero or more operands. The operands may represent, for example, a register, a constant, or a memory location. Thus, in one example, a piece of code may comprise:

mov di, ecx
push ebp, esp
mov dword ptr ss:[esp+24],1

In some cases, normalization may include considering only the mnemonic of the instruction. However, in other cases, this may result in losing the semantics of the instruction.

Thus, in one or more examples of the present Specification, assembly code normalization method provides a useful level of abstraction while still retaining the semantics of the instruction. For example, the foregoing code sample may be normalized as follows:

| | |
|---|---|
| mov di, ecx | mov REG, REG |
| push ebp, esp | push REG, REG |
| mov dword ptr ss:[esp+24],1 | mov MEM, CONST |

Thus, an assembly code normalization algorithm may class operands together, such as registers, memory locations, and constants. In this manner, the semantics of an instruction are preserved, and a match may be made even when an instruction uses different registers, constants, and/or memory locations.

Note, however, that in certain architectures, separate instruction opcodes and mnemonics may be provided for register-based operations, memory-based operations, and constant-based operations. In those cases, assembly code normalization may be minimized. In other words, in cases where the opcode or mnemonic itself carries the semantics of the instruction, the need for normalization may be reduced or eliminated.

Another technique performed by the classification engine of the present Specification is N-gram generation. An N-gram is a contiguous sequence of N items from a given sequence of instructions. An N-gram is calculated over a floating window. For example, the following sequence of instructions results in the following two 3-grams:

Original Sample:

mov REG, REG
xor REG, REG
push REG, REG
mov MEM, CONST

First 3-Gram:

mov REG, REG
xor REG, REG
push REG, REG

Second 3-Gram:

xor REG, REG
push REG, REG
mov MEM, CONST

In one example, each N-gram may be converted to a hash, such as a 32-bit hash, to reduce the complexity of comparison. Evidently, the lower the value of N in an N-gram, the higher the resolution of the comparison, and the greater the processing power required to process it.

With hashed N-grams, the similarity between the object under analysis and a known malware object may be determined. In one example, the two objects are compared via a Jaccard index. If the Jaccard index matches a predefined threshold, defined for example by a security research team, the files are deemed similar. The Jaccard index of a pair of files may be calculated according to:

$$J ( A , B ) = \frac{\vert A ⋂ B \vert}{\vert A ⋃ B \vert}$$

A prototype of a classification engine of the present Specification was experimentally run on a particular malware sample known as “Zbot.” Zbot samples diverged over time, so that after approximately one year, recent Zbot samples shared only approximately 83% of code with the original Zbot. A classification engine was able to classify test samples as belonging to the Zbot family of malware with approximately 98% accuracy.

The same prototype was also able to correctly classify other samples as belonging to the “Swizzor” family of malware, which is polymorphic, with high accuracy.

In another embodiment, a classification engine may be modified to also provide detection of “grayware” applications. These include applications that are semi-legitimate and that may provide some useful functions, but that are excessively invasive or intrusive. For example, a flashlight application for a smart phone may provide the advertised function (a flashlight), but may also perform other tasks that are completely unrelated to the advertised function, such as uploading a user's contacts, e-mails, photographs, passwords, or sensitive information.

As with the malware detection example, this embodiment of a classification engine disassembles the executable object to create an assembly listing file. The classification engine may then create a call trace from the ASM listing as described above. Also as described above, functions may be filtered according to a function blacklist and CFL.

Based on the remaining subroutines, the object may be classified according to a taxonomy. This taxonomy may be somewhat different from the taxonomy of the preceding example. While the preceding example focused on classing an object with a malware family, this taxonomy is concerned more with classifying objects according to their expected functions.

The classification engine may then generate a multigraph, receiving inputs from self-reported behavior of the object and expected behavior for the object's class. This multigraph can be used to determine whether the object is behaving as an object in this class is expected to behave. For example, an object classified as a flashlight app will be expected to provide a user interface and access the flash. It will not, however, be expected to collect user information, record audio or video, or take photographs. Thus, if the object performs those unexpected tasks, it may be flagged as grayware.

A classification engine will now be described with more particular reference to the appended FIGURES.

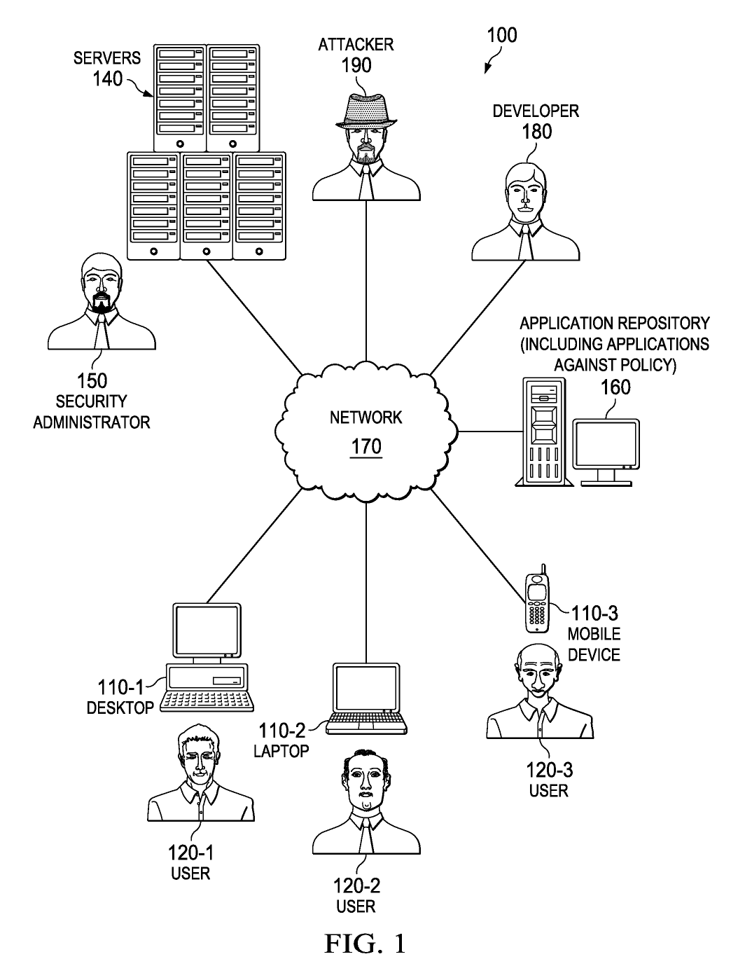

FIG. 1 is a network-level diagram of a distributed security network 100 according to one or more examples of the present Specification. In the example of FIG. 1, a plurality of users 120 operate a plurality of computing devices 110. Specifically, user 120-1 operates desktop computer 110-1. User 120-2 operates laptop computer 110-2. And user 120-3 operates mobile device 110-3.

Each computing device may include an appropriate operating system, such as Microsoft Windows, Linux, Android, Mac OSX, Apple iOS, Unix, or similar. Some of the foregoing may be more often used on one type of device than another. For example, desktop computer 110-1, which in some cases may also be an engineering workstation, may be more likely to use one of Microsoft Windows, Linux, Unix, or Mac OSX. Laptop computer 110-2, which is usually a portable off-the-shelf device with fewer customization options, may be more likely to run Microsoft Windows or Mac OSX. Mobile device 110-3 may be more likely to run Android or iOS. However, these examples are not intended to be limiting.

Computing devices 110 may be communicatively coupled to one another and to other network resources via network 170. Network 170 may be any suitable network or combination of networks, including for example, a local area network, a wide area network, a wireless network, a cellular network, or the Internet by way of nonlimiting example. In this illustration, network 170 is shown as a single network for simplicity, but in some embodiments, network 170 may include a large number of networks, such as one or more enterprise intranets connected to the internet.

Also connected to network 170 are one or more servers 140, an application repository 160, and human actors connecting through various devices, including for example an attacker 190 and a developer 180. Servers 140 may be configured to provide suitable network services including certain services disclosed in one or more examples of the present Specification. In one embodiment, servers 140 and at least a part of network 170 are administered by one or more security administrators 150.

It may be a goal of users 120 to successfully operate their respective computing devices 110 without interference from attacker 190 and developer 180. In one example, attacker 190 is a malware author whose goal or purpose is to cause malicious harm or mischief. The malicious harm or mischief may take the form of installing root kits or other malware on computing devices 110 to tamper with the system, installing spyware or adware to collect personal and commercial data, defacing websites, operating a botnet such as a spam server, or simply to annoy and harass users 120. Thus, one aim of attacker 190 may be to install his malware on one or more computing devices 110. As used throughout this Specification, malicious software (“malware”) includes any virus, trojan, zombie, rootkit, backdoor, worm, spyware, adware, ransomware, dialer, payload, malicious browser helper object, cookie, logger, or similar designed to take a potentially-unwanted action, including by way of non-limiting example data destruction, covert data collection, browser hijacking, network proxy or redirection, covert tracking, data logging, key logging, excessive or deliberate barriers to removal, contact harvesting, and unauthorized self-propagation.

Servers 140 may be operated by a suitable enterprise to provide security updates and services, including anti-malware services. Servers 140 may also provide substantive services such as routing, networking, enterprise data services, and enterprise applications. In one example, servers 140 are configured to distribute and enforce enterprise computing and security policies. These policies may be administered by security administrator 150 according to written enterprise policies. Security administrator 150 may also be responsible for administering and configuring servers 140, and all or a portion of network 170.

Developer 180 may also operate on network 170. Developer 180 may not have malicious intent, but may develop software that poses a security risk. For example, a well-known and often-exploited security flaw is the so-called buffer overrun, in which a malicious user such as attacker 190 is able to enter an overlong string into an input form and thus gain the ability to execute arbitrary instructions or operate with elevated privileges on a computing device 110. Buffer overruns may be the result, for example, of poor input validation or incomplete garbage collection, and in many cases arise in nonobvious contexts. Thus, although not malicious himself, developer 180 may provide an attack vector for attacker 190. Applications developed by developer 180 may also cause inherent problems, such as crashes, data loss, or other undesirable behavior. Developer 180 may host software himself, or may upload his software to an application repository 160. Because software from developer 180 may be desirable itself, it may be beneficial for developer 180 to occasionally provide updates or patches that repair vulnerabilities as they become known.

Application repository 160 may represent a Windows or Apple “app store,” a Unix-like repository or ports collection, or other network service providing users 120 the ability to interactively or automatically download and install applications on computing devices 110. Developer 180 and attacker 190 may both provide software via application repository 160. If application repository 160 has security measures in place that make it difficult for attacker 190 to distribute overtly malicious software, attacker 190 may instead stealthily insert vulnerabilities into apparently beneficial applications.

In some cases, one or more users 120 may belong to an enterprise. The enterprise may provide policy directives that restrict the types of applications that can be installed, for example from application repository 160. Thus, application repository 160 may include software that is not negligently developed and is not malware, but that is nevertheless against policy. For example, some enterprises restrict installation of entertainment software like media players and games. Thus, even a secure media player or game may be unsuitable for an enterprise computer. Security administrator 150 may be responsible for distributing a computing policy consistent with such restrictions.

In another example, user 120 may be a parent of young children, and wish to protect the children from undesirable content, such as pornography, adware, spyware, age-inappropriate content, advocacy for certain political, religious, or social movements, or forums for discussing illegal or dangerous activities, by way of non-limiting example. In this case, the parent may perform some or all of the duties of security administrator 150.

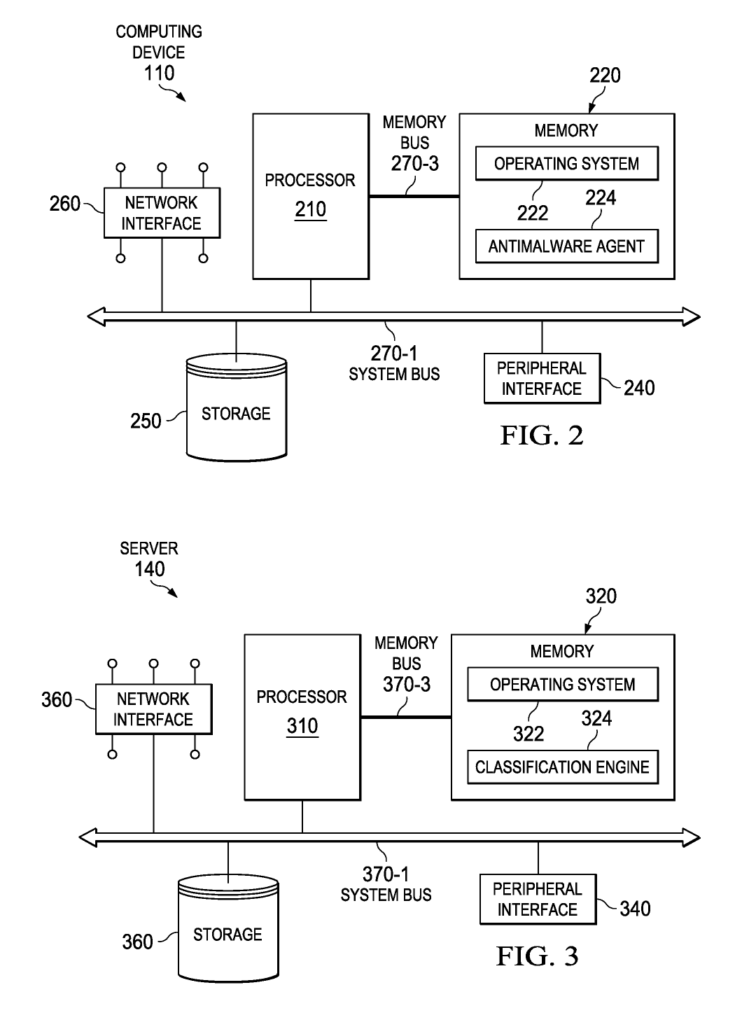

Collectively, any object that is a candidate for being one of the foregoing types of content may be referred to as “potentially unwanted content” (PUC). The “potentially” aspect of PUC means that when the object is marked as PUC, it is not necessarily blacklisted. Rather, it is a candidate for being an object that should not be allowed to reside or work on a computing device 110. Thus, it is a goal of users 120 and security administrator 150 to configure and operate computing devices 110 so as to usefully analyze PUC and make intelligent decisions about how to respond to a PUC object. This may include an agent on computing device 110, such as antimalware agent 224 of FIG. 2, which may communicate with servers 140 for additional intelligence. Servers 140 may provide network-based services, including classification engine 324 of FIG. 3, that are configured to enforce policies, and otherwise assist computing devices 110 in properly classifying and acting on PUC.

FIG. 2 is a block diagram of client device 110 according to one or more examples of the present Specification. Client device 110 may be any suitable computing device. In various embodiments, a “computing device” may be or comprise, by way of non-limiting example, a computer, embedded computer, embedded controller, embedded sensor, personal digital assistant (PDA), laptop computer, cellular telephone, IP telephone, smart phone, tablet computer, convertible tablet computer, handheld calculator, or any other electronic, microelectronic, or microelectromechanical device for processing and communicating data

Client device 110 includes a processor 210 connected to a memory 220, having stored therein executable instructions for providing an operating system 222 and antimalware agent 224. Other components of client device 110 include a storage 250, network interface 260, and peripheral interface 240.

In an example, processor 210 is communicatively coupled to memory 220 via memory bus 270-3, which may be for example a direct memory access (DMA) bus by way of example, though other memory architectures are possible, including ones in which memory 220 communicates with processor 210 via system bus 270-1 or some other bus. Processor 210 may be communicatively coupled to other devices via a system bus 270-1. As used throughout this Specification, a “bus” includes any wired or wireless interconnection line, network, connection, bundle, single bus, multiple buses, crossbar network, single-stage network, multistage network or other conduction medium operable to carry data, signals, or power between parts of a computing device, or between computing devices. It should be noted that these uses are disclosed by way of non-limiting example only, and that some embodiments may omit one or more of the foregoing buses, while others may employ additional or different buses.

In various examples, a “processor” may include any combination of hardware, software, or firmware providing programmable logic, including by way of non-limiting example a microprocessor, digital signal processor, field-programmable gate array, programmable logic array, application-specific integrated circuit, or virtual machine processor.

Processor 210 may be connected to memory 220 in a DMA configuration via DMA bus 270-3. To simplify this disclosure, memory 220 is disclosed as a single logical block, but in a physical embodiment may include one or more blocks of any suitable volatile or non-volatile memory technology or technologies, including for example DDR RAM, SRAM, DRAM, cache, L1 or L2 memory, on-chip memory, registers, flash, ROM, optical media, virtual memory regions, magnetic or tape memory, or similar. In certain embodiments, memory 220 may comprise a relatively low-latency volatile main memory, while storage 250 may comprise a relatively higher-latency non-volatile memory. However, memory 220 and storage 250 need not be physically separate devices, and in some examples may represent simply a logical separation of function. It should also be noted that although DMA is disclosed by way of non-limiting example, DMA is not the only protocol consistent with this Specification, and that other memory architectures are available.

Storage 250 may be any species of memory 220, or may be a separate device, such as a hard drive, solid-state drive, external storage, redundant array of independent disks (RAID), network-attached storage, optical storage, tape drive, backup system, cloud storage, or any combination of the foregoing. Storage 250 may be, or may include therein, a database or databases or data stored in other configurations, and may include a stored copy of operational software such as operating system 222 and software portions of antimalware agent 224. Many other configurations are also possible, and are intended to be encompassed within the broad scope of this Specification.

Network interface 260 may be provided to communicatively couple client device 110 to a wired or wireless network. A “network,” as used throughout this Specification, may include any communicative platform operable to exchange data or information within or between computing devices, including by way of non-limiting example, an ad-hoc local network, an internet architecture providing computing devices with the ability to electronically interact, a plain old telephone system (POTS), which computing devices could use to perform transactions in which they may be assisted by human operators or in which they may manually key data into a telephone or other suitable electronic equipment, any packet data network (PDN) offering a communications interface or exchange between any two nodes in a system, or any local area network (LAN), metropolitan area network (MAN), wide area network (WAN), wireless local area network (WLAN), virtual private network (VPN), intranet, or any other appropriate architecture or system that facilitates communications in a network or telephonic environment.

Antimalware agent 224, in one example, is a utility or program that receives updates from server 140 and blocks or remediates malware according to information received from server 140. In some cases, antimalware agent 224 may run as a “daemon” process. A “daemon” may include any program or series of executable instructions, whether implemented in hardware, software, firmware, or any combination thereof, that runs as a background process, a terminate-and-stay-resident program, a service, system extension, control panel, bootup procedure, BIOS subroutine, or any similar program that operates without direct user interaction. It should also be noted that antimalware agent 224 is provided by way of non-limiting example only, and that other hardware and software, including interactive or user-mode software, may also be provided in conjunction with, in addition to, or instead of antimalware agent 224 to perform methods according to this Specification.

In one example, antimalware agent 224 includes executable instructions stored on a non-transitory medium operable to perform antimalware activities. At an appropriate time, such as upon booting client device 110 or upon a command from operating system 222 or a user 120, processor 210 may retrieve a copy of antimalware agent 224 (or software portions thereof) from storage 250 and load it into memory 220. Processor 210 may then iteratively execute the instructions of antimalware agent 224.

Peripheral interface 240 may be configured to interface with any auxiliary device that connects to client device 110 but that is not necessarily a part of the core architecture of client device 110. A peripheral may be operable to provide extended functionality to client device 110, and may or may not be wholly dependent on client device 110. In some cases, a peripheral may be a computing device in its own right. Peripherals may include input and output devices such as displays, terminals, printers, keyboards, mice, modems, network controllers, sensors, transducers, actuators, controllers, data acquisition buses, cameras, microphones, speakers, or external storage by way of non-limiting example.

FIG. 3 is a block diagram of server 140 according to one or more examples of the present Specification. Server 140 may be any suitable computing device, as described in connection with FIG. 2. In general, the definitions and examples of FIG. 2 may be considered as equally applicable to FIG. 3, unless specifically stated otherwise.

Server 140 includes a processor 310 connected to a memory 320, having stored therein executable instructions for providing an operating system 322 and classification engine 324. Other components of server 140 include a storage 350, network interface 360, and peripheral interface 340.

In an example, processor 310 is communicatively coupled to memory 320 via memory bus 370-3, which may be for example a direct memory access (DMA) bus. Processor 310 may be communicatively coupled to other devices via a system bus 370-1.

Processor 310 may be connected to memory 320 in a DMA configuration via DMA bus 370-3. To simplify this disclosure, memory 320 is disclosed as a single logical block, but in a physical embodiment may include one or more blocks of any suitable volatile or non-volatile memory technology or technologies, as described in connection with memory 220 of FIG. 2. In certain embodiments, memory 320 may comprise a relatively low-latency volatile main memory, while storage 350 may comprise a relatively higher-latency non-volatile memory. However, memory 320 and storage 350 need not be physically separate devices, as further described in connection with FIG. 2

Storage 350 may be any species of memory 320, or may be a separate device, as described in connection with storage 250 of FIG. 2. Storage 350 may be, or may include therein, a database or databases or data stored in other configurations, and may include a stored copy of operational software such as operating system 322 and software portions of classification engine 324. Many other configurations are also possible, and are intended to be encompassed within the broad scope of this Specification.

Network interface 360 may be provided to communicatively couple server 140 to a wired or wireless network.

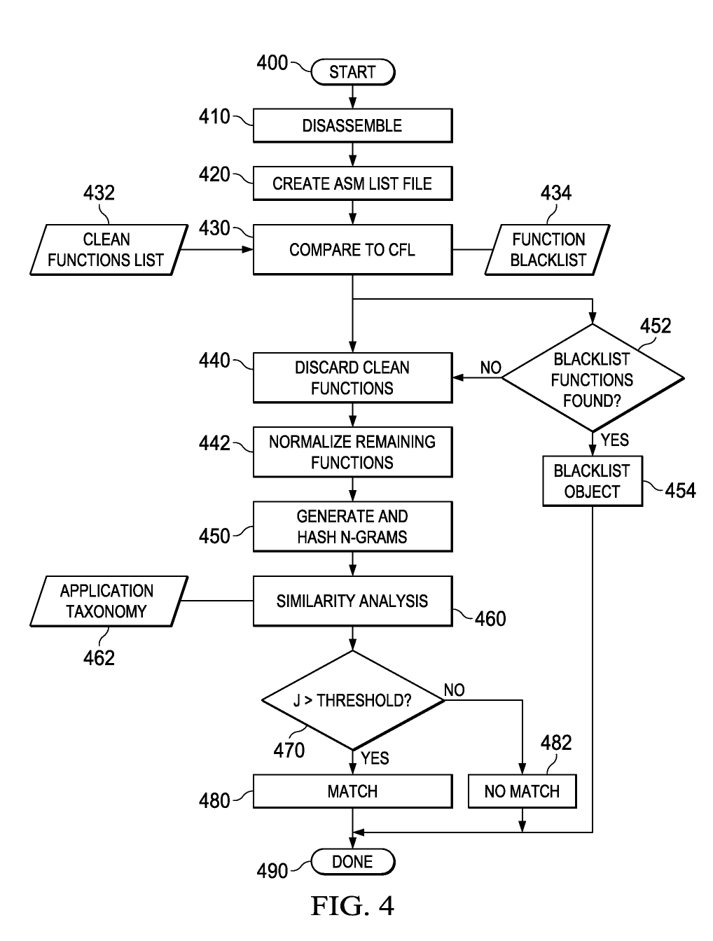

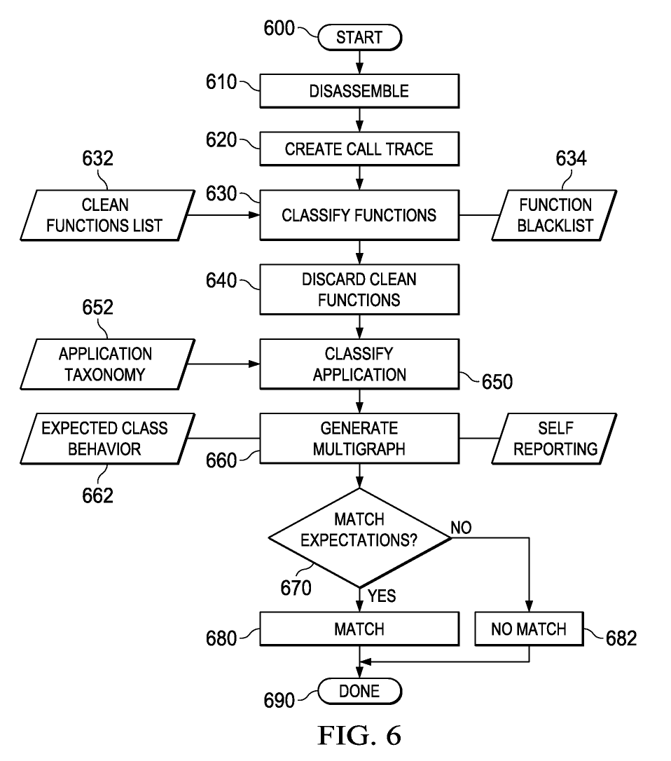

Classification engine 324, in one example, is a utility or program that carries out a method such as method 400 of FIG. 4 or method 600 of FIG. 6. Classification engine 324 may be, in various embodiments, embodied in hardware, software, firmware, or some combination thereof. For example, in some cases, classification engine 324 may include a special integrated circuit designed to carry out a method or a part thereof, and may also include software instructions operable to instruct a processor to perform the method. In some cases, classification engine 324 may run as a daemon process, as described above. It should also be noted that classification engine 324 is provided by way of non-limiting example only, and that other hardware and software, including interactive or user-mode software, may also be provided in conjunction with, in addition to, or instead of classification engine 324 to perform methods according to this Specification.

In one example, classification engine 324 includes executable instructions stored on a non-transitory medium operable to perform methods according to this Specification. At an appropriate time, such as upon booting server 140 or upon a command from operating system 322 or a user 120, processor 310 may retrieve a copy of classification engine 324 (or software portions thereof) from storage 350 and load it into memory 320. Processor 310 may then iteratively execute the instructions of classification engine 324.

Peripheral interface 340 may be configured to interface with any auxiliary device that connects to server 140 but that is not necessarily a part of the core architecture of server 140. A peripheral may be operable to provide extended functionality to server 140, and may or may not be wholly dependent on server 140. In some cases, a peripheral may be a computing device in its own right. Peripherals may include, by way of non-limiting examples, any of the devices discussed in connection with peripheral interface 240 of FIG. 2.

FIG. 4 is a flowchart of a method 400 performed by a classification engine 324 in one or more examples of the present Specification. In performing method 400, classification engine 324 may be operating specifically with the intent of matching an object under analysis to a known object with an acceptable degree of confidence. In one example, the known object has already been disassembled, analyzed, characterized, and classified according to methods disclosed herein. In method 400, classification engine 324 classifies the object under analysis as either being a match for the known object or not.

In block 410, classification engine 324 disassembles the object under analysis as described herein.

In block 420, classification engine 324 creates one or more ASM list files for the object under analysis.

In block 430, classification engine 324 compares the ASM list file to a CFL. The CFL is provided as an input from block 432. In this block, compiler-produced code may be identified, and other known good or benign subroutines may be identified. Block 430 may also receive function blacklist 434. Function blacklist 434 may include a number of functions that are known with a high degree of confidence to occur only in malware objects.

In decision block 452, classification engine 324 determines whether blacklisted functions were found. If blacklisted functions were found, then in block 454, classification engine 324 may blacklist or otherwise remediate the object under analysis. Control may then pass to block 490, and method 400 is done.

This represents an example where identification of malware objects is more important than classification of malware objects into families. If the primary goal of a particular embodiment is simply to ensure that malware objects are identified and mitigated, then the inclusion of known malware subroutines in the object under analysis may be sufficient for that purpose.

However, there are cases where it is still useful to fully classify the object. In that case, a parallel path may be followed from block 430 directly to block 440. In that case, the object may be blacklisted, but it is still useful to classify the object if possible.

Returning to block 452, if no blacklist functions were found, then control passes to block 440. As described above, control may also pass in a parallel path directly from block 430 to block 440.

In block 440, classification engine 324 discards known clean functions, such as compiler-generated code and standard library routines. As described above, these functions may not meaningfully contribute to determining whether an object is malware or not.

In block 442 classification engine 324 may normalize remaining functions. This may include classifying operands, for example, as registers, memory locations, and constants. In other cases, this may include simply keeping an opcode where the semantics of the instruction are fully determined by the opcode. The result of this normalization procedure is a normalized ASM listing.

In block 450, operating on the normalized ASM listing of block 442, classification engine 324 may generate and hash N-grams as described above. The selection of N may depend on the granularity or precision desired, and available computing resources. In one example, N is selected to be 3. In another example, N is selected to be a value from 2 to 10. These examples are nonlimiting, and are provided by way of illustration only.

In block 460, classification engine 324 receives an application taxonomy and performs similarity analysis. Application taxonomy 462 may provide, for example, a classification scheme for grouping malware objects into families. Thus, known object of this example may be classified according to this taxonomy into a malware family. The purpose of the similarity analysis of block 460 is to determine whether the first executable object should also be classified into the same malware family. As described above, similarity analysis 460 may include a Jaccard index. The result of similarity analysis is a computed variable J.

In block 470, classification engine 324 determines whether J is greater than a threshold provided. If J is greater than the threshold, then in block 480, the first executable object is deemed a match for the second executable object, and may receive the same classification.

Returning to block 470, if J is not greater than the threshold, then in block 482, the object under analysis is not considered a match for the known object.

In block 490, the method is done.

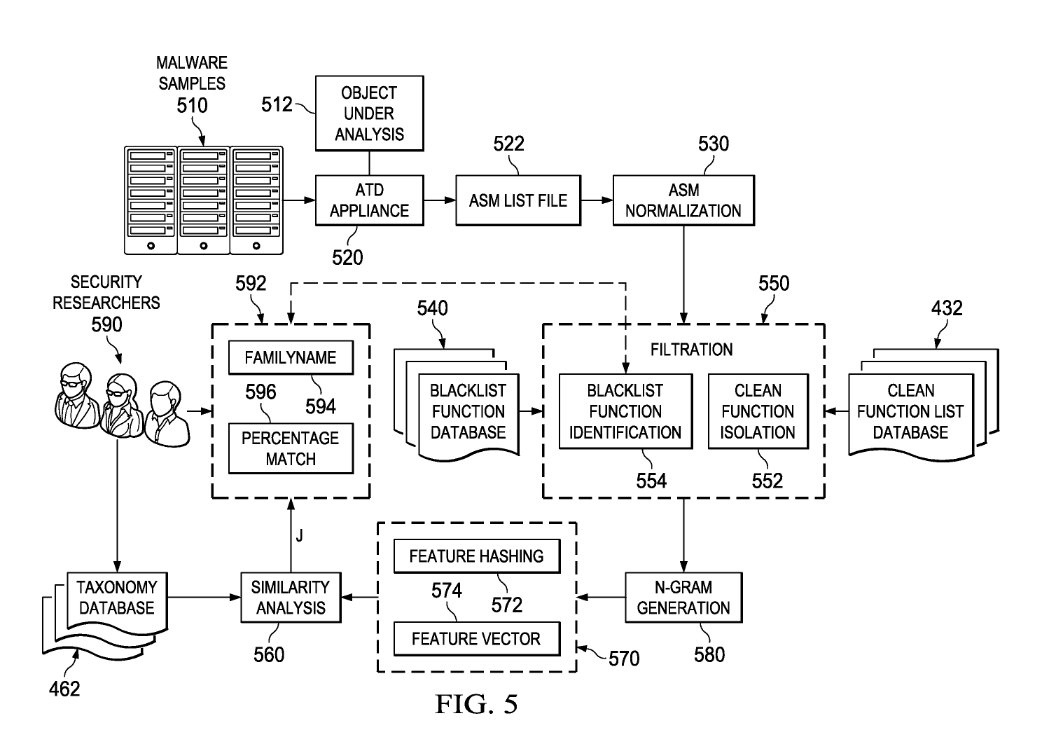

FIG. 5 is a functional block diagram of object classification according to one or more examples of the present Specification. Block 510 is a repository of malware samples. Malware samples 510 may be classified according to taxonomy, such as taxonomy 462 of FIG. 4.

Malware samples 510, as well as an object under analysis 512, may be provided to functional blocks such as a McAfee® Advanced Threat Defense (ATD) appliance 520. ATD appliance 520 may be operable to create a disassembled ASM list file 522. In some cases, ASM list file 522 may be converted to a call trace.

ASM list file 522 is provided to an ASM normalization block 530. ASM normalization block 530 performs ASM normalization as described herein, such as classifying and/or trimming out operands from mnemonics and/or opcodes. The normalized ASM file is then provided to filtration meta-block 550.

Filtration meta-block 550 receives as example inputs a blacklist function database 540, and a clean function list database 432. In block 552, filtration meta-block 550 identifies and isolates clean functions according to clean function list database 432. In block 554, filtration block 550 identifies blacklisted functions. As noted in connection with FIG. 4, in certain embodiments, the identification of one or more blacklisted functions may be sufficient to complete the necessary analysis and to blacklist the object itself. In other examples, additional analysis may be performed.

In block 580, classification engine 324 generates N-grams for analysis. In meta-block 570, classification engine 324 operates on the N-grams. This may include feature hashing 572, and feature vectors 574.

In block 560, classification engine 324 performs similarity analysis, for example according to a Jaccard index. An input to similarity analysis may be a taxonomy database 462. One or more security researchers 590 may contribute to taxonomy database 462.

Similarity analysis 560 provides a value J to meta-block 592. Meta-block 592 may receive inputs from security researchers 590, and may include classification metrics such as a family name 594, and a percentage match 596.

According to the functional block diagram of FIG. 5, object under analysis 512 is compared to one or more malware samples 510 and is classified with zero or more malware samples based on similarity analysis 560.

FIG. 6 is a flowchart of a method 600 performed by a classification engine 324 in one or more examples of the present Specification. In performing method 600, classification engine 324 may be operating specifically with the intent of identifying grayware or malware applications with high confidence. In one example, certain known objects have already been disassembled, analyzed, characterized, and classified according to methods disclosed herein. In method 600, classification engine 324 classifies the object under analysis as either legitimate or suspect.

In block 610, classification engine 324 disassembles the object under analysis as described herein.

In block 620, classification engine 324 creates one or more ASM list files for the object under analysis and generates a call trace from the ASM list file.

In block 630, classification engine 324 compares the call trace to a CFL. The CFL is provided as an input from block 632. In this block, compiler-produced code may be identified, and other known good or benign subroutines may be identified. Block 630 may also receive function blacklist 634. Function blacklist 634 may include a number of functions that are known with a high degree of confidence to occur only in malware or grayware objects.

In block 640, classification engine 324 discards known clean functions, such as compiler-generated code and standard library routines. As described above, these functions may not meaningfully contribute to determining whether an object is grayware or not.

In block 650, classification engine 324 receives an application taxonomy 652 and classifies the object under analysis according to the taxonomy.

In block 660, classification engine 324 generates a multigraph for the object under analysis, including expected class behavior 662. Multigraph generation is described in more detail in the paper “Malware Classification based on Call Graph Clustering,” by Joris Kinable and Orestis Kostakis, published Aug. 27, 2010. The paper is available as of the date of this application at http://arxiv.org/abs/1008.4365.

In decision block 670, classification engine determines whether the object under analysis matches expected behavior for its application class, as determined in block 660.

In block 680, if the behavior matches expectations, then the object under analysis may be deemed as legitimate.

In block 682, if the behavior does not match expectations, then the object under analysis may be deemed as grayware or malware as appropriate.

In block 690, the method is done.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

The particular embodiments of the present disclosure may readily include a system on chip (SOC) central processing unit (CPU) package. An SOC represents an integrated circuit (IC) that integrates components of a computer or other electronic system into a single chip. It may contain digital, analog, mixed-signal, and radio frequency functions: all of which may be provided on a single chip substrate. Other embodiments may include a multi-chip-module (MCM), with a plurality of chips located within a single electronic package and configured to interact closely with each other through the electronic package. In various other embodiments, the digital signal processing functionalities may be implemented in one or more silicon cores in Application Specific Integrated Circuits (ASICs), Field Programmable Gate Arrays (FPGAs), and other semiconductor chips.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Additionally, some of the components associated with described microprocessors may be removed, or otherwise consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, equipment options, etc.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof. In operation, processors may store information in any suitable type of non-transitory storage medium (for example, random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe. Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Computer program logic implementing all or part of the functionality described herein is embodied in various forms, including, but in no way limited to, a source code form, a computer executable form, and various intermediate forms (for example, forms generated by an assembler, compiler, linker, or locator). In an example, source code includes a series of computer program instructions implemented in various programming languages, such as an object code, an assembly language, or a high-level language such as OpenCL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In the discussions of the embodiments above, the capacitors, buffers, graphics elements, interconnect boards, clocks, DDRs, camera sensors, dividers, inductors, resistors, amplifiers, switches, digital core, transistors, and/or other components can readily be replaced, substituted, or otherwise modified in order to accommodate particular circuitry needs. Moreover, it should be noted that the use of complementary electronic devices, hardware, non-transitory software, etc. offer an equally viable option for implementing the teachings of the present disclosure.

In one example embodiment, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In another example embodiment, the electrical circuits of the FIGURES may be implemented as stand-alone modules (e.g., a device with associated components and circuitry configured to perform a specific application or function) or implemented as plug-in modules into application specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this Specification. In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “steps for” are specifically used in the particular claims; and (b) does not intend, by any statement in the Specification, to limit this disclosure in any way that is not otherwise reflected in the appended claims.

### Example Implementations

There is disclosed in an example 1, a computing apparatus comprising: a processor; and one or more logic elements comprising a classification engine operable for: disassembling an object under analysis; creating an assembly language listing of the object under analysis; comparing the assembly language listing to a known object, the known object belonging to a family in an object taxonomy; and classifying the object under analysis as belonging to the family in the object taxonomy.

There is disclosed in an example 2, the computing apparatus of example 1, wherein the classification engine is further operable for filtering known clean functions from the assembly language listing.

There is disclosed in an example 3, the computing apparatus of example 1, wherein the classification engine is further operable for: identifying at least one blacklisted function in the assembly language listing; and designating the object under analysis as a blacklisted object.

There is disclosed in an example 4, the computing apparatus of example 1, wherein the classification engine is further operable for creating a call trace of the assembly language listing.

There is disclosed in an example 5, the computing apparatus of example 1, wherein the classification engine is further operable for normalizing instructions of the assembly language listing.

There is disclosed in an example 6, the computing apparatus of example 5, wherein normalizing the assembly language listing comprises: retaining operation codes or mnemonics; and classifying operands.

There is disclosed in an example 7, the computing apparatus of example 6, wherein classifying operands comprises classifying at least some operands as one of register, memory address, and constant.

There is disclosed in an example 8, the computing apparatus of example 5, wherein instructions for the assembly language include semantics for at least some instructions, and wherein normalizing the assembly language listing comprises discarding operands for the at least some instructions including semantics.

There is disclosed in an example 9, the computing apparatus of example 1, wherein the classification engine is further operable for performing N-gram analysis on the assembly language listing.

There is disclosed in an example 10, the computing apparatus of example 9, wherein the classification engine is further operable for generating a hash of each N-gram of the N-gram analysis.

There is disclosed in an example 11, the computing apparatus of example 1, wherein the classification engine is further operable for performing a similarity analysis for the object under analysis and the known object.

There is disclosed in an example 12, the computing apparatus of example 11, wherein the similarity analysis comprises computing a Jaccard index.

There is disclosed in an example 13, the computing apparatus of example 1, wherein the known object is a malware object.

There is disclosed in an example 14, one or more computer-readable mediums having stored thereon executable instructions for instructing a processor for providing a classification engine operable for: disassembling an object under analysis;

creating an assembly language listing of the object under analysis; comparing the assembly language listing to a known object, the known object belonging to a family in an object taxonomy; and classifying the object under analysis as belonging to the family in the object taxonomy.

There is disclosed in an example 15, the one or more computer-readable mediums of example 14, wherein the classification engine is further operable for filtering known clean functions from the assembly language listing.

There is disclosed in an example 16, the one or more computer-readable mediums of example 14, wherein the classification engine is further operable for: identifying at least one blacklisted function in the assembly language listing; and designating the object under analysis as a blacklisted object.

There is disclosed in an example 17, the one or more computer-readable mediums of example 14, wherein the classification engine is further operable for creating a call trace of the object under analysis.

There is disclosed in an example 18, the one or more computer-readable mediums of example 14, wherein the classification engine is further operable for normalizing instructions of the assembly language listing.

There is disclosed in an example 19, the one or more computer-readable mediums of example 18, wherein normalizing the assembly language listing comprises: retaining operation codes or mnemonics; and classifying at least some operands as one of register, memory address, and constant.

There is disclosed in an example 20, the one or more computer-readable mediums of example 18, wherein instructions for the assembly language include semantics for at least some instructions, and wherein normalizing the assembly language listing comprises discarding operands for the at least some instructions including semantics.

There is disclosed in an example 21, the one or more computer-readable mediums of example 14, wherein the classification engine is further operable for performing N-gram analysis on the assembly language listing and generating a hash of each N-gram of the N-gram analysis.

There is disclosed in an example 22, the one or more computer-readable mediums of example 14, wherein the classification engine is further operable for performing a similarity analysis for the object under analysis and the known object, wherein the similarity analysis comprises computing a Jaccard index.

There is disclosed in an example 23, the one or more computer-readable mediums of example 14, wherein the known object is a malware object.

There is disclosed in an example 24, a computer-implemented method of providing a classification engine, comprising: disassembling an object under analysis; creating a call trace of the object under analysis; comparing the call trace to a known object, the known object belonging to a family in an object taxonomy; and generating a multigraph of the object under analysis.

There is disclosed in an example 25, the computer-implemented method of example 24, further comprising: determining that the object under analysis does not match expectations according to the multigraph; and designating the object under analysis as not belonging to the family in the object taxonomy.

There is disclosed in an example 26, a method comprising the performing the instructions disclosed in any of examples 14-23.

There is disclosed in example 27, an apparatus comprising means for performing the method of example 26.

There is disclosed in example 28, the apparatus of example 27, wherein the apparatus comprises a processor and memory.

There is disclosed in example 29, the apparatus of example 28, wherein the apparatus further comprises a computer-readable medium having stored thereon software instructions for performing the method of example 26.

What is claimed is:

1. A computing apparatus comprising:
a processor; and
one or more logic elements comprising a classification engine operable for:
disassembling an object under analysis;
creating an assembly language listing of the object under analysis;
comparing the assembly language listing to a known object, the known object belonging to a family in an object taxonomy; and
classifying the object under analysis as belonging to the family in the object taxonomy.

2. The computing apparatus of claim 1, wherein the classification engine is further operable for filtering known clean functions from the assembly language listing.

3. The computing apparatus of claim 1, wherein the classification engine is further operable for:
identifying at least one blacklisted function in the assembly language listing; and
designating the object under analysis as a blacklisted object.

4. The computing apparatus of claim 1, wherein the classification engine is further operable for creating a call trace of the assembly language listing.

5. The computing apparatus of claim 1, wherein the classification engine is further operable for normalizing instructions of the assembly language listing.

6. The computing apparatus of claim 5, wherein normalizing the assembly language listing comprises:
retaining operation codes or mnemonics; and
classifying operands.

7. The computing apparatus of claim 6, wherein classifying operands comprises classifying at least some operands as one of register, memory address, and constant.

8. The computing apparatus of claim 5, wherein instructions for the assembly language include semantics for at least some instructions, and wherein normalizing the assembly language listing comprises discarding operands for the at least some instructions including semantics.

9. The computing apparatus of claim 1, wherein the classification engine is further operable for performing N-gram analysis on the assembly language listing.

10. The computing apparatus of claim 9, wherein the classification engine is further operable for generating a hash of each N-gram of the N-gram analysis.

11. The computing apparatus of claim 1, wherein the classification engine is further operable for performing a similarity analysis for the object under analysis and the known object.

12. The computing apparatus of claim 11, wherein the similarity analysis comprises computing a Jaccard index.

13. The computing apparatus of claim 1, wherein the known object is a malware object.

14. One or more computer-readable mediums having stored thereon executable instructions for instructing a processor for providing a classification engine operable for:
disassembling an object under analysis;
creating an assembly language listing of the object under analysis;
comparing the assembly language listing to a known object, the known object belonging to a family in an object taxonomy; and
classifying the object under analysis as belonging to the family in the object taxonomy.

15. The one or more computer-readable mediums of claim 14, wherein the classification engine is further operable for filtering known clean functions from the assembly language listing.

16. The one or more computer-readable mediums of claim 14, wherein the classification engine is further operable for:
identifying at least one blacklisted function in the assembly language listing; and
designating the object under analysis as a blacklisted object.

17. The one or more computer-readable mediums of claim 14, wherein the classification engine is further operable for creating a call trace of the object under analysis.

18. The one or more computer-readable mediums of claim 14, wherein the classification engine is further operable for normalizing instructions of the assembly language listing.

19. The one or more computer-readable mediums of claim 18, wherein normalizing the assembly language listing comprises:
retaining operation codes or mnemonics; and
classifying at least some operands as one of register, memory address, and constant.

20. The one or more computer-readable mediums of claim 18, wherein instructions for the assembly language include semantics for at least some instructions, and wherein normalizing the assembly language listing comprises discarding operands for the at least some instructions including semantics.

21. The one or more computer-readable mediums of claim 14, wherein the classification engine is further operable for performing N-gram analysis on the assembly language listing and generating a hash of each N-gram of the N-gram analysis.

22. The one or more computer-readable mediums of claim 14, wherein the classification engine is further operable for performing a similarity analysis for the object under analysis and the known object, wherein the similarity analysis comprises computing a Jaccard index.

23. The one or more computer-readable mediums of claim 14, wherein the known object is a malware object.

24. A computer-implemented method of providing a classification engine, comprising:
disassembling an object under analysis;
creating a call trace of the object under analysis;
comparing the call trace to a known object, the known object belonging to a family in an object taxonomy; and
generating a multigraph of the object under analysis.

25. The computer-implemented method of claim 24, further comprising:
determining that the object under analysis does not match expectations according to the multigraph; and
designating the object under analysis as not belonging to the family in the object taxonomy.
